(19) United States
(12) Patent Application Publication
(10) Pub. No.: US 2025/0140989 A1
(43) Pub. Date: May 1, 2025

(54) INSULATION PAD FOR PREVENTING HEAT TRANSFER, METHOD OF MANUFACTURING THE SAME AND BATTERY PACK INCLUDING INSULATION PAD FOR PREVENTING HEAT TRANSFER

(71) Applicant: APIT Inc., Seoul (KR)

(72) Inventors: Hyung-Ho Park, Seoul (KR); Sang-Hyun Kim, Gyeonggi-do (KR); Taehee Kim, Seoul (KR)

(21) Appl. No.: 18/882,505

(22) Filed: Sep. 11, 2024

(30) Foreign Application Priority Data
Oct. 26, 2023 (KR) 10-2023-0144500

(51) Int. Cl. H01M 10/658; B32B 37/24; C09D 1/02; C09D 5/18; C09D 7/40; C09D 7/61; C09D 7/65; F16L 59/02

(52) U.S. Cl. CPC H01M 10/658; B32B 37/24; C09D 1/02; C09D 5/18; C09D 7/61; C09D 7/65; C09D 7/70; F16L 59/028; F16L 59/029; B32B 2037/243; B32B 2307/304; B32B 2307/4026; B32B 2457/10

(57) ABSTRACT

Provided is an insulation pad for preventing heat transfer including a first thermal protection layer composed of an inorganic material, a second thermal protection layer spaced apart from the first thermal protection layer and composed of an inorganic material, and a thermal insulation layer disposed between the first and second thermal protection layers, and including aerogel particles, a binder material, a nanofiber, a surfactant, and a pigment material.

### CROSS-REFERENCE TO RELATED APPLICATION

This application claims priority of Korean Patent Application No. 10-2023-0144500, filed on Oct. 26, 2023, in the KIPO (Korean Intellectual Property Office), the disclosure of which is incorporated herein entirely by reference.

### BACKGROUND OF THE INVENTION

### Field of the Invention

The present invention relates to an insulating member, a method of manufacturing the same, and an application thereof, and more particularly, to an insulation pad for preventing heat transfer, a method of manufacturing the same, and a battery pack to which an insulation pad for preventing heat transfer is applied.

### Description of the Related Art

The electric and power industries are rapidly expanding worldwide due to the efficiency of rechargeable energy storage systems along with renewable energy, and in particular, high-capacity battery packs are being used for electric vehicle batteries for driving and operating output. Battery packs are made up of cells which are the smallest units, modules with many cells connected, and packs which are collections of modules. During the use of these battery packs, battery cell failures may occur for various reasons (overload, overcharge, impact, defects, etc.), and these failures cause abnormal overheating symptoms. Thus, the temperature continuously rises, and a thermal runaway phenomenon occurs when the critical temperature is exceeded. When a cell is in thermal runaway mode, the heat generated in the cell may induce a thermal runaway propagation reaction in adjacent cells, creating a cascading effect that may potentially ignite the entire battery, most likely leading to a larger accident. Consequently, as demand for batteries with reduced risk of thermal runaway increases, the materials for manufacturing batteries that prevent, or delay heat diffusion are required.

Several methods have been attempted to prevent thermal runaway of these batteries, but existing technologies still have many shortcomings. A method for adding flame retardant additives to the electrolyte or using non-flammable electrolytes has been considered, but this may have a negative impact on the lifespan and electrochemical performance of lithium-ion batteries. There is a technology to insert insulation between cells or groups of cells to reduce heat transfer within a battery pack during thermal runaway propagation, but this method has the disadvantage of limiting the increase in energy capacity and weight reduction because it is disadvantageous from the perspective of weight reduction and filling.

Moreover, recently, as the heat blocking requirements for electric vehicle batteries have been remarkably strengthened from the existing heat-resistant temperature and heat resistant time condition (450° C., 5 minutes) to a condition (1000˜1200° C., 5˜10 minutes), a problem arose that it is difficult to apply many existing materials. In particular, since polymer organic materials of the plastic type are completely decomposed at high temperatures above 450° C., improvement research such as developing inorganic materials that may replace them or technologies to provide flame retardant properties are being required.

### SUMMARY OF THE INVENTION

The technological object to be achieved by the present invention is to provide an insulation pad for preventing heat transfer which may withstand high temperatures and effectively block heat and may suppress/prevent the problems such as battery thermal runaway as a result of it, and a method for manufacturing the same.

In addition, the technological object to be achieved by the present invention is to provide an insulation pad for preventing heat transfer having excellent thermal protection properties and insulating properties, and a method of manufacturing the same.

In addition, the technological object to be achieved by the present invention is to provide an insulation pad for preventing heat transfer which is easy to manufacture and has excellent performance, and a method for manufacturing the same.

In addition, the technological object to be achieved by the present invention is to provide a battery pack to which the above-described insulation pad for preventing heat transfer is applied.

The objects to be achieved by the present invention are not limited to the objects mentioned above, and other objects not mentioned may be understood by those skilled in the art from the description below.

According to one embodiment of the present invention, there is provided an insulation pad for preventing heat transfer comprising: a first thermal protection layer composed of an inorganic material; a second thermal protection layer spaced apart from the first thermal protection layer and composed of an inorganic material; and a thermal insulation layer disposed between the first and second thermal protection layers, and including aerogel particles, a binder material, a nanofiber, a surfactant, and a pigment material.

The first and second thermal protection layers may include at least one of mica, porous silica, ceramic fiber, and mineral wool.

In the thermal insulation layer, a content of the aerogel particles may be about 10 to 30 wt %, a content of the binder material (binder solid) may be about 60 to 80 wt %, a content of the nanofiber may be about 1 to 10 wt %, a content of the surfactant may be about 0.1 to 6 wt %, and a content of the pigment material may be about 1 to 10 wt %.

The binder material may be an inorganic binder material or an organic binder material. The inorganic binder material may include at least one of sodium silicate and potassium silicate. The organic binder material may include at least one of epoxy, acrylic, urethane, amino alkyd, and polyimide.

The nanofiber may include at least one of cellulose, nitrocellulose, polyester, and polyvinyl alcohol.

The pigment material may include at least one of titania, silica, and zirconia.

The thermal insulation layer may include a first thermal insulation layer in contact with the first thermal protection layer, and a second thermal insulation layer disposed between the first thermal insulation layer and the second thermal protection layer, and the second thermal insulation layer may have a thinner thickness than that of the first thermal insulation layer.

According to another embodiment of the present invention, a battery pack to which the aforementioned heat transfer prevention insulation pad is applied is provided.

According to another embodiment of the present invention, there is provided a method of manufacturing an insulation pad for preventing heat transfer comprising: preparing a first thermal protection layer composed of an inorganic material; forming a thermal insulation layer by coating an aerogel-based thermal insulation paint on one surface of the first thermal protection layer; and attaching a second thermal protection layer composed of an inorganic material to one surface of the thermal insulation layer, and wherein the thermal insulation layer is disposed between the first and second thermal protection layers.

The aerogel-based thermal insulation paint may include aerogel particles, a binder material, a nanofiber, a surfactant, a pigment material, and a solvent.

In the aerogel-based thermal insulation paint, a content of the aerogel particles may be about 5 to 15 wt %, a content of the binder material (binder solid) may be about 30 to 40 wt %, a content of the nanofiber may be about 1 to 5 wt %, a content of the surfactant may be about 0.1 to 3 wt %, and a content of the pigment material may be about 1 to 5 wt %.

The nanofiber may include at least one of cellulose, nitrocellulose, polyester, and polyvinyl alcohol.

The pigment material may include at least one of titania, silica, and zirconia.

The aerogel-based thermal insulation paint may be coated on one surface of the first thermal protection layer by a spray coating method.

The first and second thermal protection layers may include at least one of mica, porous silica, ceramic fiber, and mineral wool.

According to another embodiment of the present invention, there is provided an insulation pad for preventing heat transfer comprising: a plate-shaped member; and a thermal insulation layer coated on a surface of the plate-shaped member, and including aerogel particles, a binder material, a nanofiber, a surfactant, and a pigment material.

The plate-shaped member may include at least one of siloxane, polyolefin, polyurethane, phenol, melamine, cellulose acetate, and polystyrene, or the plate-shaped member may include at least one of mica, porous silica, ceramic fiber, and mineral wool.

In the thermal insulation layer, a content of the aerogel particles may be about 10 to 30 wt %, a content of the binder material (binder solid) may be about 60 to 80 wt %, a content of the nanofiber may be about 1 to 10 wt %, a content of the surfactant may be about 0.1 to 6 wt %, and a content of the pigment material may be about 1 to 10 wt %.

The binder material may be an inorganic binder material, and the inorganic binder material may include at least one of sodium silicate and potassium silicate.

The nanofiber may include at least one of cellulose, nitrocellulose, polyester, and polyvinyl alcohol.

The pigment material may include at least one of titania, silica, and zirconia.

The thermal insulation layer may be formed to cover both surfaces of the plate-shaped member.

According to another embodiment of the present invention, a battery pack to which the above-described heat transfer prevention insulation pad is applied is provided.

According to another embodiment of the present invention, there is provided a method of manufacturing an insulation pad for preventing heat transfer comprising: preparing a plate-shaped member; and forming a thermal insulation layer by coating an aerogel-based thermal insulation paint on a surface of the plate-shaped member.

The aerogel-based thermal insulation paint may include aerogel particles, a binder material, nanofibers, a surfactant, a pigment material, and a solvent.

In the aerogel-based thermal insulation paint, a content of the aerogel particles may be about 5 to 15 wt %, a content of the binder material (binder solid) may be about 30 to 40 wt %, a content of the nanofibers may be about 1 to 5 wt %, a content of the surfactant may be about 0.1 to 3 wt %, and a content of the pigment material may be about 1 to 5 wt %.

The nanofiber may include at least one of cellulose, nitrocellulose, polyester, and polyvinyl alcohol.

The pigment material may include at least one of titania, silica, and zirconia.

The aerogel-based thermal insulation paint may be coated on the surface of the plate-shaped member by a spray coating method.

The plate-shaped member may include at least one of siloxane, polyolefin, polyurethane, phenol, melamine, cellulose acetate, and polystyrene, or the plate-shaped member may include at least one of mica, porous silica, ceramic fiber, and mineral wool.

According to embodiments of the present invention, it is possible to implement an insulation pad for preventing heat transfer which may withstand high temperatures and effectively block heat so that the problems such as battery thermal runaway may be suppressed/prevented. According to embodiments of the present invention, it is possible to implement an insulation pad for a heat transfer prevention which is provided with excellent thermal protection properties and insulation properties.

In addition, according to embodiments of the present invention, the above-described insulation pad for preventing heat transfer may be easily manufactured by using a method of applying (coating) an aerogel-based thermal insulation paint having a given configuration to a predetermined base layer (coating target layer).

When applying an insulating pad for preventing heat transfer according to an embodiment, a battery pack in which problems such as thermal runaway are suppressed may be manufactured.

However, the effects of the present invention are not limited to the effects, and may be variously expanded within a scope that does not depart from the technological spirit and scope of the present invention.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view illustrating an insulation pad for preventing heat transfer according to one embodiment of the present invention.

FIGS. 2A to 2C are perspective views illustrating a method of manufacturing an insulation pad for preventing heat transfer according to one embodiment of the present invention.

FIG. 3 is a drawing explaining the composition of an aerogel-based thermal insulation paint which may be applied to the manufacture of an insulation pad for preventing heat transfer according to one embodiment of the present invention.

FIG. 4 is a cross-sectional view illustrating an insulation pad for preventing heat transfer according to another embodiment of the present invention.

FIGS. 5A to 5C are cross-sectional views illustrating a method of manufacturing an insulation pad for preventing heat transfer according to another embodiment of the present invention.

FIG. 6 is a perspective view illustrating an insulation pad for preventing heat transfer according to another embodiment of the present invention.

FIGS. 7A to 7C are perspective views illustrating a method of manufacturing an insulation pad for preventing heat transfer according to another embodiment of the present invention.

FIG. 8 is a drawing for explaining the composition of an aerogel-based thermal insulation paint which may be applied to the manufacture of an insulation pad for preventing heat transfer according to another embodiment of the present invention.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

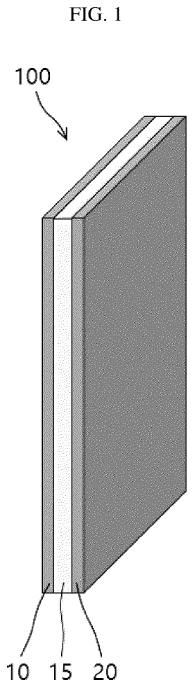

FIG. 1 is a perspective view illustrating an insulation pad 100 for preventing heat transfer according to one embodiment of the present invention.

Referring to FIG. 1, the insulation pad 100 for preventing heat transfer according to one embodiment of the present invention may include a first thermal protection layer 10 composed of an inorganic material, a second thermal protection layer 20 spaced apart from the first thermal protection layer 10 and composed of an inorganic material, and a thermal insulation layer 15 disposed between the first and second thermal protection layers 10 and 20. The thermal insulation layer 15 may include aerogel particles, a binder material, a nanofiber (nanofibers), a surfactant, and a pigment material.

The first and second thermal protection layers 10 and 20 may be composed of inorganic materials and may have characteristics capable of withstanding high temperature heat. The first and second thermal protection layers 10 and 20 may, for example, withstand temperatures of about 1000° C. or higher. For example, the first and second thermal protection layers 10 and 20 may include at least one of mica, porous silica, ceramic fiber, and mineral wool. Here, the porous silica may be microporous silica.

The thermal insulation layer 15 disposed between the first and second thermal protection layers 10 and 20 may be an aerogel-based thermal insulation layer. The thermal insulation layer 15 may effectively block heat transfer. The insulation pad 100 for preventing heat transfer including the first and second heat-protecting layers 10 and 20 and the thermal insulation layer 15 disposed therebetween may effectively block heat transfer while withstanding high temperature heat. The insulation pad 100 for preventing heat transfer may be used as an insulation pad for preventing thermal runaway of a battery. Therefore, the insulation pad 100 for preventing heat transfer may be an insulation pad for preventing thermal runaway of a battery. The insulation pad 100 for preventing heat transfer may be referred to as an insulating composite layer.

In an embodiment of the present invention, the thermal insulation layer 15 may be a coating layer formed by coating an aerogel-based thermal insulation paint on the first surface of the first thermal protection layer 10. The aerogel-based thermal insulation paint may be composed of aerogel particles (powder), a binder material, a nanofiber (nanofibers), a surfactant, a pigment material, and a solvent. The thermal insulation layer 15 may be obtained by forming a coating layer by coating the above-mentioned aerogel-based thermal insulation paint, and drying the coating layer to remove the solvent. Accordingly, the thermal insulation layer 15 may include aerogel particles, a binder material, a nanofiber (nanofibers), a surfactant, and a pigment material. The thermal insulation layer 15 may exhibit parameters similar to the properties of an aerogel having ultra-insulating and ultra-lightweight characteristics. Excellent film quality and insulating properties may be secured by using the above-mentioned aerogel-based thermal insulation paint, and since coating and bonding processes may be used, the ease of the manufacturing process may be greatly improved.

According to one embodiment, the content of the aerogel particles in the thermal insulation layer 15 may be about 10 to 30 wt %, the content of the binder material (binder solid content) may be about 60 to 80 wt %, the content of the nanofiber may be about 1 to 10 wt %, the content of the surfactant may be about 0.1 to 6 wt %, and the content of the pigment material may be about 1 to 10 wt %. If these conditions are satisfied, it may be advantageous to secure excellent film quality and insulation properties. Meanwhile, the volume ratio of the aerogel particles in the thermal insulation layer 15 may be about 40 to 70 vol %.

The aerogel particles may have a hydrophobic functional group. As a non-limiting example, the aerogel particles may include silica aerogel, but the specific constituent material is not limited to silica aerogel and may vary. The average diameter of the aerogel particles may be, for example, in a range of about 0.1 to 500 μm. The aerogel particles may have a porosity of, for example, about 70% or more or about 80% or more.

The binder material may be an inorganic binder material or an organic binder material. The inorganic binder material may include, for example, but is not limited to, at least one of sodium silicate and potassium silicate. The organic binder material may include, but is not limited to, at least one of an epoxy, an acrylic, a urethane, an amino alkyd, and a polyimide. The binder material may be or may include a type of resin. The binder material may play a role in providing flexibility and workability to the aerogel-based thermal insulation paint. In addition, the binder material may play a role in holding the aerogel particles and increasing the strength of the thermal insulation layer 15.

The nanofiber may be an inorganic material-based nanofiber or an organic material-based nanofiber. For example, the nanofiber may include at least one of cellulose, nitrocellulose, polyester, and polyvinyl alcohol. The nanofibers may play a role in improving dispersibility by preventing aerogel powder from agglomerating in the above-described aerogel-based thermal insulation paint, and may play a role in further lowering the thermal conductivity of the thermal insulation layer 15.

The surfactant may play a role in improving the mixing property when mixing the aerogel powder having hydrophobicity with a solvent (e.g., water). For example, the surfactant may improve the mixing properties of the aerogel powder and the aqueous binder solution. Accordingly, the surfactant may play a role in improving the film quality and uniformity of the thermal insulation layer 15. As a non-limiting example, the surfactant may include at least one of Span 85, Span 65, Tween 60, Brij 58, and sodium lauryl sulfate. Here, Span 85, Span 65, Tween 60, and Brij 58 are trade names.

The pigment material is a material different from the aerogel, and may play a role in controlling the viscosity of the aerogel-based thermal insulation paint, and further, may play a role in improving the strength of the coating film after coating of the aerogel-based thermal insulation paint. For example, the pigment material may include at least one of titania, silica, and zirconia, but is not limited thereto. The pigment material may have a particle form.

The thermal insulation layer 15 is a layer based on aerogel and may exhibit properties similar to aerogel. Aerogel is a material wherein secondary particles (size: approximately 5 nm) which are formed by the agglomeration of very small primary particles of approximately 1 nm or less are connected like beads, and a spider web-like structure is formed throughout the material. Since the aerogels have a large void space and surface area inside the material, they exhibit super-insulating and ultra-low-density properties. Thermal conductivity may be suppressed by a special mechanism unique to aerogels. Among the three heat transfer methods, convection occurs when the phonon mean free path in air is approximately 70 nm or longer. Since the interior of the aerogel material may be composed of mesopores (pore size approximately 10 to 20 nm), as the movement of air is restricted, the convection phenomenon may be suppressed. In the case of a conductive phenomenon, conduction in an insulator is determined by the mobility of phonons. Since the aerogels have a structure in which the interfaces of gas and solids intersect continuously, phonon scattering is maximized, and heat transfer may be suppressed. In addition, aerogels may have various advantages such as lightness, absorbency (sound absorption), and non-flammability due to their high porosity as well as high insulation properties.

According to an embodiment of the present invention, an aerogel having the lowest thermal conductivity (about 0.020 W/m·K or less) and light weight (about 0.07 g/cc or less) among materials may be used together with a binder to manufacture an aerogel insulation pad for preventing heat transfer. As the aerogel insulation pad for preventing heat transfer has strong insulating performance (about 0.035 W/m·K or less) and is lightweight (about 0.60 g/cc or less) even when mixed (inserted) between battery cells and groups of battery cells with a thin thickness (e.g., about 1 mm or less), it does not have a detrimental effect on weight reduction and filling, and may prevent and to cope with the accidents caused by battery thermal runaway.

According to an embodiment of the present invention, a battery pack to which the above-described insulation pad 100 for preventing heat transfer is applied may be implemented. The insulation pad 100 for preventing heat transfer may be placed between battery cells or between battery modules. The insulation pad 100 for preventing heat transfer may effectively suppress thermal runaway phenomena of the battery pack. The battery pack may include, for example, a lithium-ion battery, but is not limited thereto, and the specific type of the battery may vary. The insulation pad 100 for preventing heat transfer of the present invention may be applied to any general secondary battery type battery, regardless of the type.

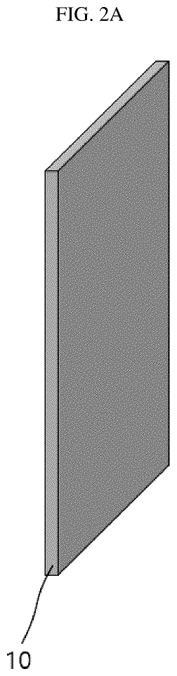

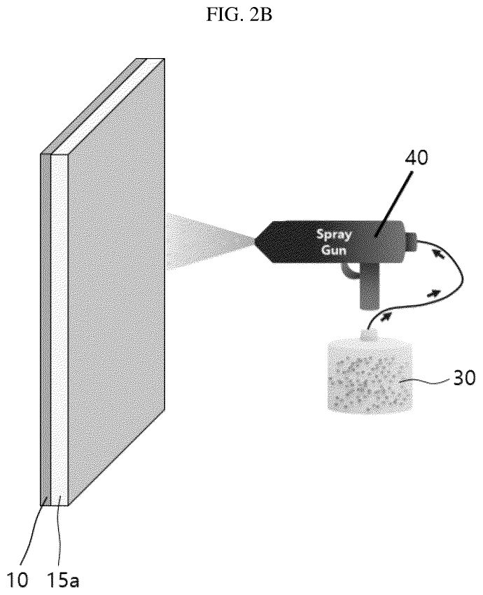

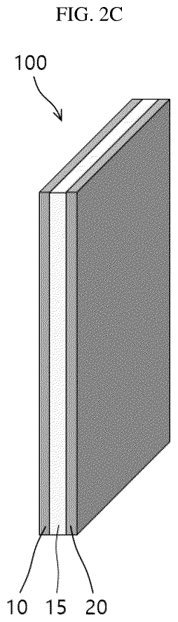

FIGS. 2A to 2C are perspective views illustrating a method of manufacturing an insulation pad for preventing heat transfer according to one embodiment of the present invention.

Referring to FIG. 2A, a first thermal protection layer 10 composed of an inorganic material may be prepared. For example, the first thermal protection layer 10 may include at least one of mica, porous silica, ceramic fiber, and mineral wool. Here, the porous silica may be microporous silica.

Referring to FIG. 2B, an aerogel-based thermal insulation paint 30 may be coated on one surface of the first thermal protection layer 10 to form a coating layer 15a. The coating layer 15a may be an insulation coating layer (i.e., a thermal insulation layer). For example, the aerogel-based thermal insulation paint 30 may be coated on one surface of the first thermal protection layer 10 by a spray coating method. The reference numeral 40 indicates a spray gun. When using a spray coating method, the manufacturing process may be easily performed, and mass production may be possible. In the embodiment of the present invention, since a thermal insulation layer (15 in FIG. 2C) is formed by applying the aerogel-based thermal insulation paint 30, the easiness of the manufacturing process may be greatly improved. The method of separately manufacturing an aerogel-based insulation layer and then bonding it to a thermal protection layer may tremendously reduce productivity. Since the embodiment of the present invention uses a method of applying (coating) the aerogel-based thermal insulation paint 30, productivity may be improved.

Referring to FIG. 2C, a second thermal protection layer 20 composed of an inorganic material may be attached to one surface of a thermal insulation layer 15 corresponding to the coating layer (15a of FIG. 2B). The thermal insulation layer 15 may be placed between the first and second thermal protection layers 10 and 20. For example, the second thermal protection layer 20 may include at least one of mica, porous silica, ceramic fiber, and mineral wool. Here, the porous silica may be microporous silica.

The attachment process may be easily performed without using a separate adhesive by attaching the second thermal protection layer 20 to the thermal insulation layer 15 before the thermal insulation layer 15 is completely dry while the adhesive properties of the thermal insulation layer 15 are excellent. In other words, the attachment process may be easily performed by attaching the second thermal protection layer 20 to the coating layer (15a of FIG. 2B) before the coating layer (15a of FIG. 2B) is completely dry. After attaching the second thermal protection layer 20, a drying process may be further performed on the thermal insulation layer 15. As a result, an insulation pad 100 for preventing heat transfer as described in FIG. 1 may be manufactured.

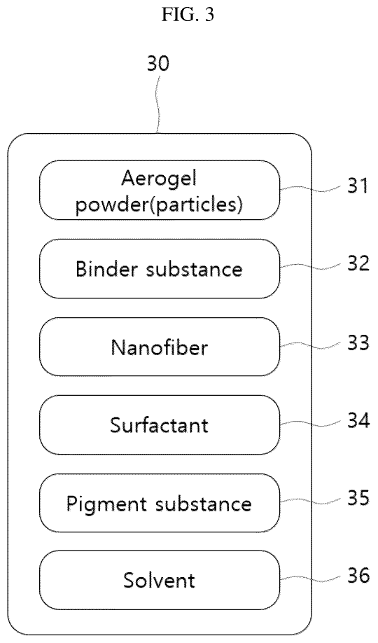

FIG. 3 is a drawing explaining the composition of an aerogel-based thermal insulation paint 30 which may be applied to the manufacture of an insulation pad for preventing heat transfer according to one embodiment of the present invention.

Referring to FIG. 3, an aerogel-based thermal insulation paint 30 which may be applied to the manufacture of an insulation pad for preventing heat transfer according to one embodiment of the present invention may include aerogel powder (particles) 31, a binder material 32, a nanofiber (nanofibers) 33, a surfactant 34, a pigment material 35, and a solvent 36.

According to one embodiment, in the aerogel-based thermal insulation paint 30, the content of the aerogel powder 31 may be about 5 to 15 wt %, the content of the binder material 32 may be about 30 to 40 wt %, the content of the nanofiber (nanofibers) 33 may be about 1 to 5 wt %, the content of the surfactant 34 may be about 0.1 to 3 wt %, and the content of the pigment material 35 may be about 1 to 5 wt %. The content of the solvent 36 in the aerogel-based thermal insulation paint 30 may be about 20 to 55 wt %. When this condition is satisfied, it may be advantageous to secure excellent film quality and insulating properties of the thermal insulation layer. In addition, the aerogel-based thermal insulation paint 30 and the coating layer formed by coating it may have excellent adhesiveness.

The aerogel powder 31 may have a hydrophobic functional group. As a non-limiting example, the aerogel powder 31 may include silica aerogel, but the specific constituent material is not limited to silica aerogel and may vary. The average diameter of the particles of the aerogel powder 31 may be, for example, in a range of about 0.1 to 500 μm. The particles of the aerogel powder 31 may have, for example, a porosity of about 70% or more or about 80% or more.

The binder material 32 may have a hydrophilic

functional group. The binder material 32 may have a characteristic that it is well dissolved in water. The binder material 32 may be an inorganic binder material or an organic binder material. The inorganic binder material may include, for example, at least one of sodium silicate and potassium silicate, but is not limited thereto. The organic binder material may include, for example, at least one of epoxy, acrylic, urethane, amino alkyd, and polyimide, but is not limited to. The binder material 32 may be or include a type of resin. The binder material 32 may play a role in providing flexibility and workability to the aerogel-based thermal insulation paint 30. In addition, the binder material 32 may play a role in increasing the strength of the thermal insulation layer while holding the aerogel particles.

The nanofiber 33 may be an inorganic material-based nanofiber or an organic material-based nanofiber. For example, the nanofiber 33 may include at least one of cellulose, nitrocellulose, polyester, and polyvinyl alcohol. The nanofiber 33 may play a role in improving dispersibility by preventing aerogel powder 31 from agglomerating in the aerogel-based thermal insulation paint 30 and may further lower the thermal conductivity of the thermal insulation layer.

The surfactant 34 may play a role in improving the mixing property when mixing the aerogel powder 31 having hydrophobicity with the solvent 36. For example, the surfactant 34 may improve the mixing properties of the aerogel powder 31 and the aqueous binder solution. Therefore, the surfactant 34 may play a role in improving the film quality and uniformity of the thermal insulation layer. As a non-limiting example, the surfactant 34 may include at least one of Span 85, Span 65, Tween 60, Brij 58, and sodium lauryl sulfate.

The pigment material 35 is a material different from the aerogel, and may play a role in controlling the viscosity of the aerogel-based thermal insulation paint 30, and may also play a role in improving the strength of the coating film after coating the aerogel-based thermal insulation paint 30. For example, the pigment material 35 may include at least one of titania, silica, and zirconia, but is not limited thereto. The pigment material 35 may have a particle form.

The solvent 36 may, for example, include or be water. Accordingly, the aerogel-based thermal insulation paint 30 may be a water-based paint. If the aerogel-based thermal insulation paint 30 is a water-based paint, it may have relatively excellent safety. The aerogel powder 31, the binder material 32, the nanofiber 33, the surfactant 34, and the pigment material 35 may be homogeneously dispersed and mixed within the solvent 36. However, in some cases, the solvent 36 may further include another solvent in addition to water.

As a specific example, the aerogel-based thermal insulation paint 30 may be manufactured by sequentially mixing the aerogel powder 31, the nanofiber 33, the surfactant 34, and the pigment material 35 into an aqueous binder solution containing the binder material 32 and the solvent 36, and then sufficiently dispersing the materials through high-speed stirring at a speed of about 1200 to 2400 rpm. Here, the solvent 36 may be water (purified water).

According to one embodiment, in the aerogel-based thermal insulation paint 30, the content of the aerogel powder 31 may be about 5 to 15 wt %, the content of the binder material 32 may be about 30 to 40 wt %, the content of the nanofiber 33 may be about 1 to 5 wt %, the content of the surfactant 34 may be about 0.1 to 3 wt %, and the content of the pigment material 35 may be about 1 to 5 wt %. When these conditions are satisfied, it may be more advantageous to improve the properties of the aerogel-based thermal insulation paint 30 such as dispersibility, stability, insulating properties, lightness, and workability.

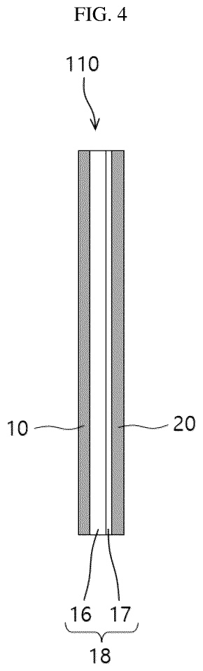

FIG. 4 is a cross-sectional view illustrating an insulation pad 110 for preventing heat transfer according to another embodiment of the present invention.

Referring to FIG. 4, the insulation pad 110 for preventing heat transfer according to the present embodiment may include a first thermal protection layer 10 composed of an inorganic material, a second thermal protection layer 20 spaced apart from the first thermal protection layer 10 and composed of an inorganic material, and a thermal insulation layer 18 disposed between the first and second thermal protection layers 10 and 20. The thermal insulation layer 18 may include aerogel particles, a binder material, a nanofiber (nanofibers), a surfactant, and a pigment material.

The thermal insulation layer 18 may include a first thermal insulation layer 16 in adjacent to (in contact with) the first thermal protection layer 10 and a second thermal insulation layer 17 arranged between the first thermal insulation layer 16 and the second thermal protection layer 20. The first and second thermal insulation layers 16 and 17 may be coating layers formed by coating an aerogel-based thermal insulation paint. The aerogel-based thermal insulation paint may be the same as described with reference to FIG. 3. The second thermal insulation layer 17 may have a thinner thickness than that of the first thermal insulation layer 16. When the thermal insulation layer 18 is configured to include the first and second thermal insulation layers 16 and 17, the effect that the drying process time in the manufacturing process is shortened may be obtained.

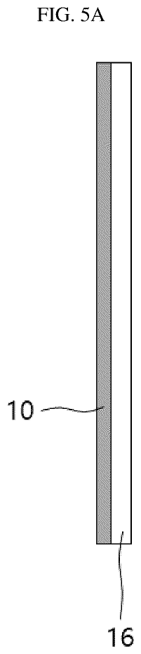

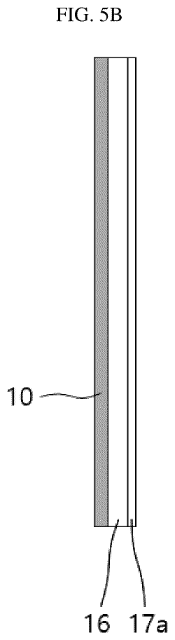

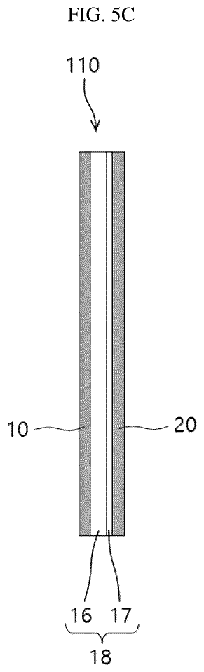

FIGS. 5A to 5C are cross-sectional views illustrating a method of manufacturing an insulation pad for preventing heat transfer according to another embodiment of the present invention.

Referring to FIG. 5A, after preparing a first thermal protection layer 10 composed of an inorganic material, an aerogel-based thermal insulation paint may be coated on one surface of the first thermal protection layer 10 to form a first thermal insulation layer 16. After coating the aerogel-based thermal insulation paint to form a first coating layer, the first coating layer may be dried to obtain the first thermal insulation layer 16.

Referring to FIG. 5B, a second coating layer 17a may be formed by coating an aerogel-based thermal insulation paint on one surface of the first thermal insulation layer 16. The second coating layer 17a may be an insulation coating layer (i.e., a thermal insulation layer). The second coating layer 17a may have a relatively thinner thickness than that of the first thermal insulation layer 16. The second coating layer 17a may be used as an adhesive layer for attaching a second thermal protection layer 20 in a subsequent process.

Referring to FIG. 5C, a second thermal protection layer 20 composed of an inorganic material may be attached to one surface of the second thermal insulation layer 17 corresponding to the second coating layer (17a of FIG. 5B). The second thermal protection layer 20 may include, for example, at least one of mica, porous silica, ceramic fiber, and mineral wool. Here, the porous silica may be microporous silica.

The attachment process may be easily performed by attaching the second thermal protection layer 20 to the second thermal insulation layer 17 while the adhesive properties of the second thermal insulation layer 17 are excellent before the second thermal insulation layer 17 is completely dry. In other words, the attachment process may be easily performed by attaching the second thermal protection layer 20 to the second coating layer (17a of FIG. 5B) before the second coating layer (17a of FIG. 5B) is completely dried. After attaching the second thermal protection layer 20, a drying process may be further performed on the second thermal insulation layer 17. As a result, an insulation pad 110 for preventing heat transfer as described in FIG. 4 may be manufactured. The first and second thermal insulation layers 16 and 17 may form a thermal insulation layer 18.

First of all, after forming the first thermal insulation layer 16 having a relatively thick thickness and drying it, and forming the second thermal insulation layer 17 having a thin thickness, the second thermal protection layer 20 may be attached before the second thermal insulation layer 17 is completely dried. In this case, the effect that the time for the overall drying process is shortened may be obtained.

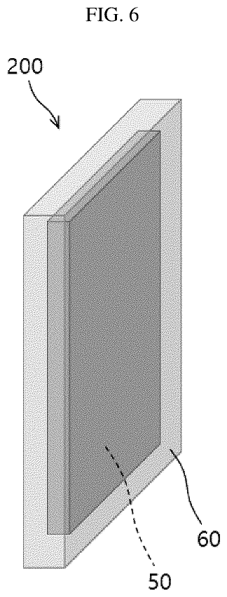

FIG. 6 is a perspective view illustrating an insulation pad 200 for preventing heat transfer according to another embodiment of the present invention.

Referring to FIG. 6, the insulation pad 200 for preventing heat transfer according to the present embodiment may include a plate-shaped member 50 and a thermal insulation layer 60 coated on the surface of the plate-shaped member 50. The thermal insulation layer 60 may include aerogel particles, a binder material, a nanofiber (nanofibers), a surfactant, and a pigment material. The material composition of the thermal insulation layer 60 may be the same as or similar to the material composition of the thermal insulation layer 15 described with reference to FIG. 1. However, the binder material included in the thermal insulation layer 60 may be an inorganic binder material.

The plate-shaped member 50 may serve to improve the physical strength of the insulation pad 200 for preventing heat transfer, and may also serve to improve heat resistance. The plate-shaped member 50 may include an organic material or an inorganic material. For example, the plate-shaped member 50 may include at least one of siloxane, polyolefin, polyurethane, phenol, melamine, cellulose acetate, and polystyrene, or may be configured by including at least one of mica, porous silica, ceramic fiber, and mineral wool. Additionally, in some cases, the plate-shaped member 50 may be composed of at least two materials selected from siloxane, polyolefin, polyurethane, phenol, melamine, cellulose acetate, polystyrene, mica, porous silica, ceramic fiber, and mineral wool. Here, the porous silica may be microporous silica.

The thermal insulation layer 60 may serve to provide thermal protection performance and thermal insulation properties to the plate-shaped member 50. The thermal insulation layer 60 may be an aerogel-based thermal insulation layer. The thermal insulation layer 60 may be formed to cover both surfaces of the plate-shaped member 50. The thermal insulation layer 60 may be formed to cover both surfaces and side surfaces of the plate-shaped member 50. The thermal insulation layer 60 may be formed to completely surround the plate-shaped member 50. However, in some cases, a portion of the surface of the plate-shaped member 50 may be exposed and not covered by the thermal insulation layer 60.

In this embodiment, the thermal insulation layer 60 may be a coating layer formed by coating an aerogel-based thermal insulation paint on the surface of a plate-shaped member 50. The aerogel-based thermal insulation paint may be composed of aerogel particles (powder), a binder material, a nanofiber (nanofibers), a surfactant, a pigment material, and a solvent. The thermal insulation layer 60 may be obtained by forming a coating layer by coating the above-mentioned aerogel-based thermal insulation paint and drying the coating layer to remove the solvent. Accordingly, the thermal insulation layer 60 may include aerogel particles, a binder material, a nanofiber (nanofibers), a surfactant, and a pigment material. The thermal insulation layer 60 may exhibit parameters similar to the properties of aerogel having ultra-insulating and ultra-light characteristics. Excellent film quality and insulating properties may be secured by using the above-described aerogel-based thermal insulation paint, and since a coating process may be used, the easiness of the manufacturing process may be greatly improved.

According to one embodiment, in the thermal insulation layer 60, the content of the aerogel particles may be about 10 to 30 wt %, the content of the binder material may be about 60 to 80 wt %, the content of the nanofiber (nanofibers) may be about 1 to 10 wt %, the content of the surfactant may be about 0.1 to 6 wt %, and the content of the pigment material may be about 1 to 10 wt %. If these conditions are satisfied, it may be advantageous to secure excellent film quality and insulation properties. Meanwhile, the volume ratio of the aerogel particles in the thermal insulation layer 60 may be about 40 to 70 vol %.

The aerogel particles may have a hydrophobic functional group. As a non-limiting example, the aerogel particles may include silica aerogel, but the specific constituent material is not limited to silica aerogel and may vary. The average diameter of the aerogel particles may be, for example, in a range of about 0.1 to 500 μm. The aerogel particles may have, for example, a porosity of about 70% or more or about 80% or more.

The binder material may be an inorganic binder material. The inorganic binder material may include, for example, at least one of sodium silicate and potassium silicate, but is not limited thereto. The binder material may be or include a kind of resin. The binder material may play a role in providing flexibility and workability to the aerogel-based thermal insulation paint. In addition, the binder material may play a role in increasing the strength of the thermal insulation layer 60 while holding the aerogel particles.

The nanofiber may be an inorganic material-based nanofiber or an organic material-based nanofiber. For example, the nanofiber may include at least one of cellulose, nitrocellulose, polyester, and polyvinyl alcohol. The nanofiber may play a role in improving dispersibility by preventing aerogel powder from agglomerating in the above-described aerogel-based thermal insulation paint, and may play a role in further lowering the thermal conductivity of the thermal insulation layer 60.

The surfactant may play a role in improving the mixing property when mixing the aerogel powder having hydrophobicity with a solvent (e.g., water). For example, the surfactant may improve the mixing properties of the aerogel powder and the aqueous binder solution. Accordingly, the surfactant may play a role in improving the film quality and uniformity of the thermal insulation layer 60. As a non-limiting example, the surfactant may include at least one of Span 85, Span 65, Tween 60, Brij 58, and sodium lauryl sulfate.

The pigment material is a material different from aerogel and may play a role in controlling the viscosity of the aerogel-based thermal insulation paint, and also may play a role in improving the strength of the coating film after coating of the aerogel-based thermal insulation paint. For example, the pigment material may include, but is not limited to, at least one of titania, silica and zirconia. The pigment material may have a particle form.

According to an embodiment of the present invention, a battery pack to which the above-described insulation pad 200 for preventing heat transfer is applied may be implemented. The insulation pad 200 for preventing heat transfer may be placed between battery cells or between battery modules. The insulation pad 200 for preventing heat transfer may effectively suppress thermal runaway phenomena of the battery pack. The battery pack may include, for example, a lithium-ion battery, but is not limited thereto, and the specific type of the battery may vary. The insulation pad 200 for preventing heat transfer of the present invention may be applied to any general secondary battery type battery, regardless of the type.

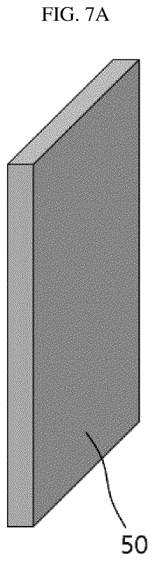

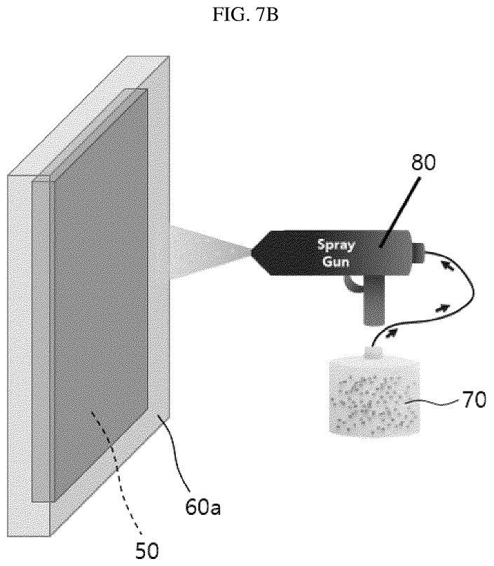

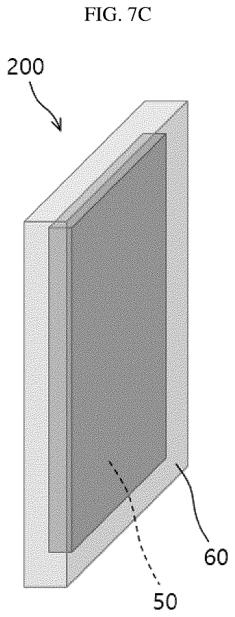

FIGS. 7A to 7C are perspective views illustrating a method of manufacturing an insulation pad for preventing heat transfer according to another embodiment of the present invention.

Referring to FIG. 7A, a plate-shaped member 50 may be prepared. The plate-shaped member 50 may include an organic material or an inorganic material. For example, the plate-shaped member 50 may include at least one of siloxane, polyolefin, polyurethane, phenol, melamine, cellulose acetate, and polystyrene, or may be composed to include at least one of mica, porous silica, ceramic fiber, and mineral wool. Additionally, in some cases, the plate-shaped member 50 may be composed of at least two of siloxane, polyolefin, polyurethane, phenol, melamine, cellulose acetate, polystyrene, mica, porous silica, ceramic fiber, and mineral wool. Here, the porous silica may be microporous silica.

Referring to FIG. 7B, an aerogel-based thermal insulation paint 70 may be coated on the surface of a plate-shaped member 50 to form a coating layer 60a. The coating layer 60a may be an insulation coating layer (i.e., a thermal insulation layer). For example, the aerogel-based thermal insulation paint 70 may be coated on the surface of the plate-shaped member 50 by a spray coating method. The reference numeral 80 indicates a spray gun. When using a spray coating method, the manufacturing process may be easy and mass production is possible. In the embodiment of the present invention, since a thermal insulation layer (60 in FIG. 7C) is formed by applying an aerogel-based thermal insulation paint 70, the easiness of the manufacturing process may be greatly improved.

Referring to FIG. 7C, a thermal insulation layer 60 may be obtained by drying the coating layer (60a of FIG. 7B) to remove the solvent. As a result, an insulation pad 200 for preventing heat transfer as described in FIG. 6 may be manufactured. The insulation pad 200 for preventing heat transfer may have excellent thermal protection performance and thermal insulation properties.

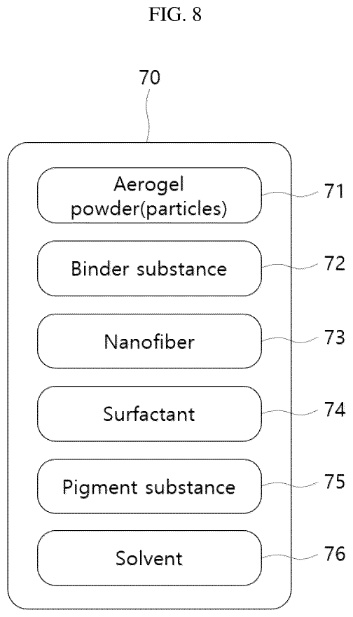

FIG. 8 is a drawing explaining the composition of an aerogel-based thermal insulation paint 70 which may be applied to the manufacture of an insulation pad for preventing heat transfer according to another embodiment of the present invention.

Referring to FIG. 8, the composition of an aerogel-based thermal insulation paint 70 which may be applied to the manufacture of an insulation pad for preventing heat transfer according to another embodiment of the present invention may be the same as or similar to the aerogel-based thermal insulation paint 30 described in FIG. 3. The aerogel-based thermal insulation paint 70 may include aerogel powder (particles) 71, a binder material 72, a nanofiber (nanofibers) 73, a surfactant 74, a pigment material 75, and a solvent 76. The binder material 72 may be an inorganic binder material.

According to one embodiment, in the aerogel-based thermal insulation paint 70, the content of the aerogel powder 71 may be about 5 to 15 wt %, the content of the binder material 72 may be about 30 to 40 wt %, the content of the nanofiber (nanofibers) 73 may be about 1 to 5 wt %, the content of the surfactant 74 may be about 0.1 to 3 wt %, and the content of the pigment material 75 may be about 3 to 5 wt %. The content of the solvent 76 in the aerogel-based thermal insulation paint 70 may be about 20 to 55 wt %. When this condition is satisfied, it may be advantageous to secure excellent film quality and insulating properties of the thermal insulation layer.

The aerogel powder (particle) 71, the nanofiber 73, the surfactant 74, the pigment material 75, and the solvent 76 may be the same as the aerogel powder (particle) 31, the nanofiber 33, the surfactant 34, the pigment material 35, and the solvent 36 described in FIG. 3, respectively, and therefore, a repeated description thereof is omitted.

The binder material 72 may have a hydrophilic functional group. The binder material 72 may have a characteristic that it is well dissolved in water. The binder material 72 may be an inorganic binder material. The inorganic binder material may include, for example, at least one of sodium silicate and potassium silicate, but is not limited thereto. The binder material 72 may be or include a type of resin. The binder material 72 may play a role in providing flexibility and workability to the aerogel-based thermal insulation paint 70. In addition, the binder material 72 may play a role in increasing the strength of the thermal insulation layer while holding the aerogel particles.

As a specific example, the aerogel-based thermal insulation paint 70 may be manufactured by sequentially mixing the aerogel powder 71, the nanofiber 73, the surfactant 74, and the pigment material 75 into an aqueous binder solution containing the binder material 72 and the solvent 76, and then sufficiently dispersing the materials through high-speed stirring at a speed of about 1200 to 2400 rpm. Here, the solvent 76 may be water (purified water).

According to the embodiments of the present invention described above, it is possible to implement an insulation pad for preventing heat transfer which may withstand high temperatures and effectively block heat, and as a result of it, the problems such as battery thermal runaway may be suppressed/prevented. According to the embodiments of the present invention, it is possible to implement a heat transfer prevention insulation pad which is provided with excellent thermal protection properties and insulation properties. In addition, according to embodiments of the present invention, the above-described insulation pad for preventing heat transfer may be easily manufactured by using a method of applying (coating) an aerogel-based thermal insulation paint having a given configuration to a predetermined base layer (a coating target layer). When applying the insulation pad for preventing heat transfer according to the embodiment, a battery pack in which problems such as thermal runaway are suppressed may be manufactured.

In the present specification, the preferred embodiments of the present invention have been disclosed, and although specific terms are used, these are only used in a general sense to easily describe the technological contents of the present invention and to help the understanding of the present invention, and are not used to limit the scope of the present invention. It will be apparent to those of ordinary skill in the art to which the present invention pertains that other modifications based on the technological spirit of the present invention may be implemented in addition to the embodiments disclosed herein. It will be appreciated to those of ordinary skill in the art that insulation pads for preventing heat transfer, methods of manufacturing the same, and battery packs including an insulation pad for preventing heat transfer according to embodiments described with reference to FIGS. 1 to 8 may be variously substituted, changed and modified without departing from the spirit of the present invention. Therefore, the scope of the invention should not be determined by the described embodiments, but should be determined by the technological concepts described in the claims.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims. The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An insulation pad for preventing heat transfer comprising:
a first thermal protection layer composed of an inorganic material;
a second thermal protection layer spaced apart from the first thermal protection layer and composed of an inorganic material; and
a thermal insulation layer disposed between the first and second thermal protection layers, and including aerogel particles, a binder material, a nanofiber, a surfactant, and a pigment material.

2. The insulation pad for preventing heat transfer of claim 1, wherein the first and second thermal protection layers include at least one of mica, porous silica, ceramic fiber, and mineral wool.

3. The insulation pad for preventing heat transfer of claim 1, wherein in the thermal insulation layer, a content of the aerogel particles is 10 to 30 wt %, a content of the binder material is 60 to 80 wt %, a content of the nanofiber is 1 to 10 wt %, a content of the surfactant is 0.1 to 6 wt %, and a content of the pigment material is 1 to 10 wt %.

4. The insulation pad for preventing heat transfer of claim 1,
wherein the binder material is an inorganic binder material or an organic binder material,
wherein the inorganic binder material includes at least one of sodium silicate and potassium silicate,
wherein the organic binder material includes at least one of epoxy, acrylic, urethane, amino alkyd, and polyimide.

5. The insulation pad for preventing heat transfer of claim 1,
wherein the nanofiber includes at least one of cellulose, nitrocellulose, polyester, and polyvinyl alcohol,
wherein the pigment material includes at least one of titania, silica, and zirconia.

6. The insulation pad for preventing heat transfer of claim 1,
wherein the thermal insulation layer includes a first thermal insulation layer in contact with the first thermal protection layer, and a second thermal insulation layer disposed between the first thermal insulation layer and the second thermal protection layer,
wherein the second thermal insulation layer has a thinner thickness than that of the first thermal insulation layer.

7. A battery pack to which an insulation pad for preventing heat transfer as described in claim 1 is applied.

8. A method of manufacturing an insulation pad for preventing heat transfer comprising:
preparing a first thermal protection layer composed of an inorganic material;
forming a thermal insulation layer by coating an aerogel-based thermal insulation paint on one surface of the first thermal protection layer; and
attaching a second thermal protection layer composed of an inorganic material to one surface of the thermal insulation layer,
wherein the thermal insulation layer is disposed between the first and second thermal protection layers.

9. The method of manufacturing an insulation pad for preventing heat transfer of claim 8,
wherein the aerogel-based thermal insulation paint includes aerogel particles, a binder material, a nanofiber, a surfactant, a pigment material, and a solvent,
wherein in the aerogel-based thermal insulation paint, a content of the aerogel particles is 5 to 15 wt %, a content of the binder material is 30 to 40 wt %, a content of the nanofiber is 1 to 5 wt %, a content of the surfactant is 0.1 to 3 wt %, and a content of the pigment material is 1 to 5 wt %.

10. The method of manufacturing an insulation pad for preventing heat transfer of claim 9,
wherein the nanofiber includes at least one of cellulose, nitrocellulose, polyester, and polyvinyl alcohol,
wherein the pigment material includes at least one of titania, silica, and zirconia.

11. The method of manufacturing an insulation pad for preventing heat transfer of claim 8, wherein the aerogel-based thermal insulation paint is coated on one surface of the first thermal protection layer by a spray coating method.

12. The method of manufacturing an insulation pad for preventing heat transfer of claim 8, wherein the first and second thermal protection layers include at least one of mica, porous silica, ceramic fiber, and mineral wool.

13. An insulation pad for preventing heat transfer comprising:
a plate-shaped member; and
a thermal insulation layer coated on a surface of the plate-shaped member, and including aerogel particles, a binder material, a nanofiber, a surfactant, and a pigment material.

14. The insulation pad for preventing heat transfer of claim 13, wherein the plate-shaped member includes at least one of siloxane, polyolefin, polyurethane, phenol, melamine, cellulose acetate, and polystyrene, or the plate-shaped member includes at least one of mica, porous silica, ceramic fiber, and mineral wool.

15. The insulation pad for preventing heat transfer of claim 13, wherein in the thermal insulation layer, a content of the aerogel particles is 10 to 30 wt %, a content of the binder material is 60 to 80 wt %, a content of the nanofiber is 1 to 10 wt %, a content of the surfactant is 0.1 to 6 wt %, and a content of the pigment material is 1 to 10 wt %.

16. The insulation pad for preventing heat transfer of claim 13,
wherein the binder material is an inorganic binder material,
wherein the inorganic binder material includes at least one of sodium silicate and potassium silicate.

17. The insulation pad for preventing heat transfer of claim 13,
wherein the nanofiber includes at least one of cellulose, nitrocellulose, polyester, and polyvinyl alcohol,
wherein the pigment material includes at least one of titania, silica, and zirconia.

18. The insulation pad for preventing heat transfer of claim 13, wherein the thermal insulation layer is formed to cover both surfaces of the plate-shaped member.

19. A battery pack to which an insulation pad for preventing heat transfer as described in claim 13 is applied.

20. A method of manufacturing an insulation pad for preventing heat transfer comprising:
preparing a plate-shaped member; and
forming a thermal insulation layer by coating an aerogel-based thermal insulation paint on a surface of the plate-shaped member.

21. The method of manufacturing an insulation pad for preventing heat transfer of claim 20,
wherein the aerogel-based thermal insulation paint includes aerogel particles, a binder material, a nanofiber, a surfactant, a pigment material, and a solvent,
wherein in the aerogel-based thermal insulation paint, a content of the aerogel particles is 5 to 15 wt %, a content of the binder material is 30 to 40 wt %, a content of the nanofibers is 1 to 5 wt %, a content of the surfactant is 0.1 to 3 wt %, and a content of the pigment material is 1 to 5 wt %.

22. The method of manufacturing an insulation pad for preventing heat transfer of claim 21,
wherein the nanofiber includes at least one of cellulose, nitrocellulose, polyester, and polyvinyl alcohol,
wherein the pigment material includes at least one of titania, silica, and zirconia.

23. The method of manufacturing an insulation pad for preventing heat transfer of claim 20, wherein the aerogel-based thermal insulation paint is coated on the surface of the plate-shaped member by a spray coating method.
